(19) United States
(12) Patent Application Publication
(10) Pub. No.: US 2012/0151012 A1
(43) Pub. Date: Jun. 14, 2012

(54) INTERNET DELIVERY OF SCHEDULED MULTIMEDIA CONTENT

(76) Inventor: Shakeel MUSTAFA, Fremont, CA (US)

(21) Appl. No.: 13/313,861

(22) Filed: Dec. 7, 2011

Related U.S. Application Data
(60) Provisional application No. 61/421,496, filed on Dec. 9, 2010.

(51) Int. Cl. G06F 15/16

(52) U.S. Cl. 709/219

(57) ABSTRACT

A method for providing scheduled multimedia content comprises selecting at least one multimedia content for Internet delivery from a plurality of multimedia content available for Internet delivery. A time to deliver the selected at least one multimedia content is scheduled. Each selected multimedia content has a corresponding scheduled time for delivery. The scheduled time for delivery of the selected multimedia content is recorded in a calendar. The calendar is operable to deliver the scheduled multimedia content at the scheduled time for delivery to an Internet-connected device connected to the calendar via the Internet.

### CROSS-REFERENCES TO RELATED APPLICATIONS

This application claims the benefit of U.S. Provisional Application No. 61/421,496, filed Dec. 9, 2010, which is related to U.S. patent application Ser. No. 12/174,083, filed Jul. 16, 2008, entitled “INTERNET MULTIMEDIA CONTENT DELIVERY TO CONSUMER ELECTRONIC DEVICES THROUGH WIRELESS NETWORK INFRASTRUCTURE.”

### TECHNICAL FIELD

The present disclosure relates generally to the field of internet content delivery and more specifically to the field of internet content delivery of a plurality of multimedia sources.

### BACKGROUND

Multimedia is media that can utilize a combination of different content forms. For example, multimedia can include a combination of text, audio, still images, animation, video, and/or interactivity content forms. Multimedia is usually recorded, played, displayed, and/or accessed by information content processing devices. For example, video and/or audio can be recorded and played back on smart phones or tablet computers, while other devices, such as desktop computers, TV's, radios, and others are capable of receiving and displaying and playing the multimedia content. Such multimedia content can be created by the user or made available for purchase. Such multimedia content made available for purchase can come in a variety of formats, such as a audio or video file that is downloaded from a content provider such as the music and video service provided by Apple, Inc or other retail establishments with Internet-based services. Multimedia content can also be purchased from retail establishments, with the content recorded onto audio compact discs (audio CDs) for audio content or optical discs (digital video disc (DVD) or Blu-ray discs (BD)) for all forms of multimedia content.

Internet multimedia data is a resource that can be accessed via the Internet. A user can access a particular Internet multimedia data by requesting the data from a server. For example, a customer may play a song or watch a movie by logging onto a music or movie servicing website and filling out the request. The song or movie may be played using the very computer used for the request. Such services may be searchable and can provide a streamed multimedia content. Examples include the websites youtube.com and hulu.com. While YouTube™, a multimedia-sharing website, provides users a way to upload, view and share videos with others, Hulu™ and other services like it provide ad-supported on-demand streaming video of television programming as well as other media. Such on-demand services can also offer premium programming for on-demand streaming video for a subscription. Other streaming services such as Pandora® offer streaming audio content based upon a listener's selected preferences.

Therefore, a listener or viewer has a variety of different methods for enjoying Internet-provided multimedia content. However, it can be distracting and time consuming for the listener or viewer to enjoy a variety of different Internet-delivered multimedia contents. Receiving streaming multimedia content from multiple providers can require logging on to different websites for each source of multimedia content. For example, for a listener enjoying the streaming audio provided by an audio content streaming service (such as provided by Pandora®) there is no way to acquire other multimedia content as provided by other streaming services (such as by YouTube™ or Hulu™) without leaving the original service and going to another. Such disconnections from one service and connections to another service can be time consuming and difficult for the user who may also need to pay attention to other activities, such as a driver of a vehicle wanting to change to a different service also delivering streaming audio content.

### SUMMARY OF THE INVENTION

Embodiments of the present invention provide a solution to the challenges inherent in delivering and/or receiving multimedia content from multiple internet multimedia content delivery services. Embodiments of the present invention provide a method for delivering a plurality of multimedia content from a plurality of multimedia servers accessed through the Internet according to a date and time scheduled for each multimedia content of the plurality of multimedia content in a calendar.

According to one embodiment of the present invention, a method for providing scheduled multimedia content is disclosed. This method comprises selecting at least one multimedia content for Internet delivery from a plurality of multimedia content available for Internet delivery. A time to deliver the selected at least one multimedia content is scheduled. Each selected multimedia content has a corresponding scheduled time for delivery. The scheduled time for delivery of the selected multimedia content is recorded in a calendar. The calendar is operable to deliver the scheduled multimedia content at the scheduled time for delivery to an Internet-connected device connected to the calendar via the Internet.

According to one embodiment of the present invention, a method for selecting, saving a location for, and downloading multimedia is disclosed. In a method according to one embodiment of the present invention, the method comprises searching for at least one data file on a webpage according to a selected criteria. The searching results in at least one identified data file as meeting the selected criteria. At least one of the at least one identified data file is selected that meets the selected criteria. A location of the at least one selected data file is saved.

### BRIEF DESCRIPTION OF THE DRAWINGS

The present invention will be better understood from a reading of the following detailed description, taken in conjunction with the accompanying drawing figures in which like reference characters designate like elements and in which:

FIG. 1 illustrates an exemplary simplified block diagram of a computer network infrastructure delivering Internet content in accordance with an embodiment of the present invention;

FIG. 2 illustrates an exemplary simplified block diagram of a computer network infrastructure delivering Internet content that is searchable in accordance with an embodiment of the present invention;

FIG. 3 illustrates an exemplary flow diagram, illustrating the steps to method for searching a webpage for multimedia content in accordance with an embodiment of the present invention;

FIG. 4 illustrates an exemplary simplified block diagram of a computer network infrastructure delivering Internet content with a customizable application for scheduled multimedia content delivery in accordance with an embodiment of the present invention;

FIG. 5A illustrates an exemplary graphical user interface of a software widget for scheduling streaming multimedia content in accordance with an embodiment of the present invention;

FIG. 5B illustrates an exemplary graphical user interface of a software widget for scheduling streaming multimedia content in accordance with an embodiment of the present invention;

FIG. 5C illustrates an exemplary graphical user interface of a software widget for scheduling streaming multimedia content in accordance with an embodiment of the present invention;

FIG. 5D illustrates an exemplary graphical user interface of a software widget for scheduling streaming multimedia content in accordance with an embodiment of the present invention;

FIG. 5E illustrates an exemplary graphical user interface of a software widget for scheduling streaming multimedia content in accordance with an embodiment of the present invention;

FIG. 6 illustrates an exemplary widget application embedded into a webpage in accordance with an embodiment of the present invention;

FIG. 7 illustrates an exemplary graphical user interface of a software widget for scheduling streaming multimedia content in accordance with an embodiment of the present invention;

FIG. 8 illustrates an exemplary graphical user interface of a software widget with a chat function in accordance with an embodiment of the present invention;

FIG. 9 illustrates exemplary simplified diagram of a chat function matching chat messages with replies;

FIG. 10 illustrates an exemplary graphical user interface of a software widget with chat functionality embedded in a webpage in accordance with an embodiment of the present invention;

FIG. 11 illustrates an exemplary simplified folder hierarchy for folders storing multimedia content and virtual paths to other multimedia content in accordance with an embodiment of the present invention;

FIG. 12 illustrates an exemplary calendar for a scheduling application for scheduling the delivery of multimedia content in accordance with an embodiment of the present invention;

FIG. 13 illustrates an exemplary diagram for managing assigning royalty fees for multimedia content as well as managing access to multimedia content folders in accordance with an embodiment of the present invention;

FIG. 14 illustrates an exemplary diagram for sending and receiving multimedia packets for a multimedia chat function in accordance with an embodiment of the present invention;

FIG. 15 illustrates an exemplary diagram for sending and receiving multimedia packets for a multimedia chat function in accordance with an embodiment of the present invention;

FIG. 16 illustrates an exemplary diagram for sending and receiving multimedia packets for a multimedia chat function in accordance with an embodiment of the present invention;

FIG. 17 illustrates an exemplary diagram for managing royalty fees received from delivered multimedia content in accordance with an embodiment of the present invention;

FIG. 18 illustrates an exemplary flow diagram illustrating the steps to a method for managing access to multimedia folders in accordance with an embodiment of the present invention;

FIG. 19 illustrates an exemplary flow diagram illustrating the steps to a method for searching for multimedia content on unreserved websites in accordance with an embodiment of the present invention;

FIG. 20 illustrates an exemplary flow diagram illustrating the steps to a method for indexing multimedia content discovered during webpage searches in accordance with an embodiment of the present invention;

FIG. 21 illustrates an exemplary flow diagram illustrating the steps to a method for backing up local files to a remote server in accordance with an embodiment of the present invention;

FIG. 22 illustrates an exemplary flow diagram illustrating the steps to a method for searching for multimedia content with software and hardware drivers in accordance with an embodiment of the present invention;

FIG. 23 illustrates an exemplary flow diagram illustrating the steps to a method for sending and receiving multimedia mail in accordance with an embodiment of the present invention;

FIG. 24 illustrates an exemplary diagram for transferring multimedia contents between a user's folders and the public folder of another user in accordance with an embodiment of the present invention; and

FIG. 25 illustrates an exemplary graphical user interface for a software widget implementing a scheduling service for streaming multimedia content in accordance with an embodiment of the present invention;

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Internet Content Delivery Networks:

This present invention provides a solution to the increasing challenges inherent in providing streaming multimedia content delivery through conventional internet-based delivery methods. Embodiments of the present invention discussed in detail below provide a method for delivering a plurality of multimedia content from a plurality of multimedia servers accessed through the Internet according to a date and time scheduled for each multimedia content of the plurality of multimedia content in at least one calendar of a plurality of calendars. Further, each scheduled date/time can appear in more than one calendar.

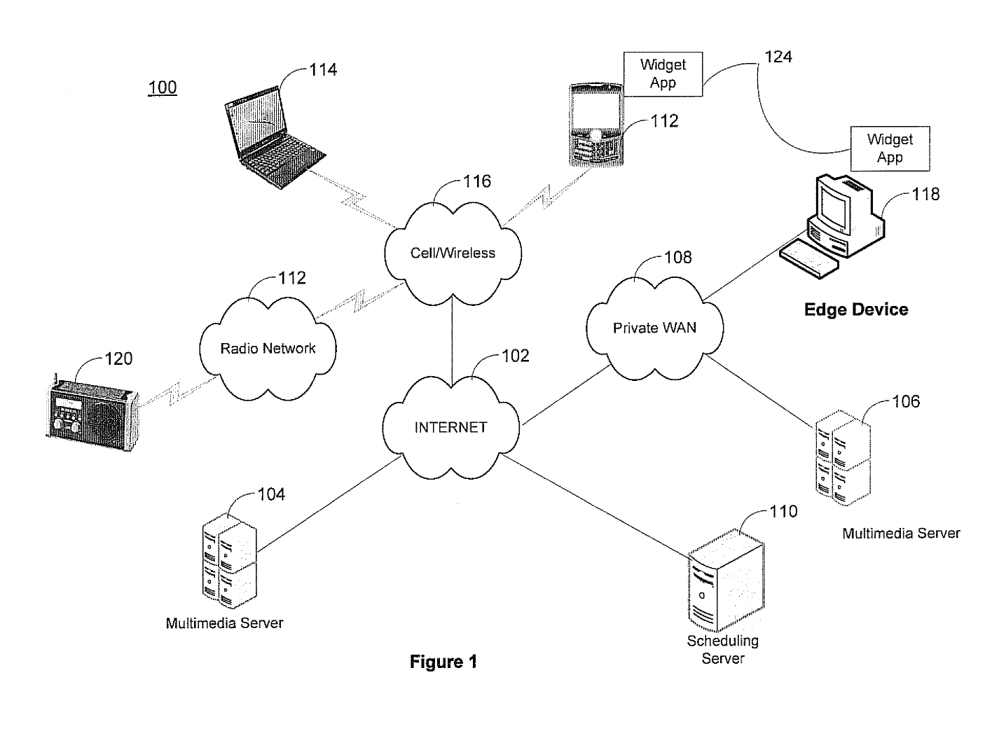

FIG. 1 illustrates an exemplary computer network capable of providing an Internet infrastructure 100. As illustrated in FIG. 1, an Internet infrastructure 100 can comprise a plurality of interconnected computer networks 102, also known as the Internet 102. Connected to the Internet 102 is a plurality of multimedia servers, such as multimedia server 104, as well as multimedia server 106 connected to the Internet 102 through a private WAN 108. As discussed above and below, the multimedia servers 104, 106 can store the multimedia files accessible through the above described multimedia content delivery services. As also illustrated in FIG. 1, and discussed below, a multimedia content scheduling service implemented with a scheduling server 110 can also store multimedia content that can be accessed and downloaded by embodiments of the present invention. As also illustrated in FIG. 1, a smart phone 112 and a wireless-enabled laptop computer 114 can connect to the Internet 102 through a cellular wireless network 116. Furthermore, an edge device 118 can also be connected to the Internet 102 through the private WAN 108. Lastly, a radio 120 can also be connected to the internet via a radio network 122 and the cellular wireless network 116. Such a connection to the Internet 102 for a radio 120 is discussed by Shakeel Mustafa in the related U.S. patent application Ser. No. 12/174,083, filed Jul. 16, 2008, entitled “INTERNET MULTIMEDIA CONTENT DELIVERY TO CONSUMER ELECTRONIC DEVICES THROUGH WIRELESS NETWORK INFRASTRUCTURE.”

As also illustrated in FIG. 1, a software widget app 124, for scheduling multimedia content streaming, found on the smart phone 112, as well as on the edge device 118, is able to search for desired multimedia content located on the multimedia servers 104, 106, as well as the scheduling server 110. As described below, the widget 124 can save a date and time for streaming of the desired multimedia content. As discussed below, the date and time for the streaming of the desired multimedia content is saved into a scheduling application (e.g., one of a plurality of calendars of the scheduling application). The scheduling server 110 (of the scheduling service provider) is also capable of receiving particular search commands from the software widget 124 and performing the searches for desired multimedia content contained in the scheduling server 110. The widget 124 can search the multimedia servers 104, 106 for the desired content and the URL address or virtual path to the discovered multimedia content saved to the scheduling server 110. As discussed above, the multimedia servers can be servers containing the multimedia contents provided by, for example, YouTube™ or Hulu™.

When a desired multimedia content has been identified, a URL address or virtual path to the desired multimedia content can be saved in the scheduling server 110. The scheduling server 110 can also save a scheduled date and time for streaming the desired multimedia content. The scheduled date and time can be saved to one or more Internet-accessible calendars saved in the scheduling server 110. Therefore, as discussed in detail below, at a desired date and time, as found in an “active” calendar, the desired multimedia content can be streamed to a desired Internet connected device, such as the radio 120, the laptop 114, the smart phone 112, or the edge device 118. In one exemplary embodiment, Internet-connected devices can make use of a private network that directly connects to the scheduling server 110. In one exemplary embodiment, a calendar is “active” when an Internet-connected device has accessed and opened the calendar.

In one exemplary embodiment, the Internet-connected device (e.g., smart phone 112 or edge device 118) requesting the desired multimedia content can be different from a desired destination device. In one exemplary embodiment, a software widget 124 in a smart phone 112 can search for desired multimedia content on the multimedia servers 104, 106. Once the desired multimedia content has been found, the requesting smart phone 112 can be used to select a date and time in a calendar for the streaming of the located multimedia content. In one embodiment, a destination device, such as an Internet-connected device other than the requesting smart phone 112 can activate the calendar (by opening the calendar) that contains the scheduled date and time for multimedia content delivery, and at the scheduled date and time, the desired multimedia content will be streamed to the destination device that has opened the calendar.

The scheduling server 110 uses a stored virtual path or URL address to the desired multimedia content for accessing and streaming the multimedia content to the destination device. In other words, only the virtual path or URL address to the desired multimedia content is stored in the scheduling server 110, rather than the actual multimedia content. In another embodiment, other devices connected to the Internet 102 can also have the software widget 124. In one embodiment a software widget 124 for accessing the scheduling service provider's services is required for saving a date and time for streaming of a multimedia content in a calendar stored in the scheduling server 110, but the software widget 124 is not needed for accessing and activating a calendar for receiving the streamed multimedia content.

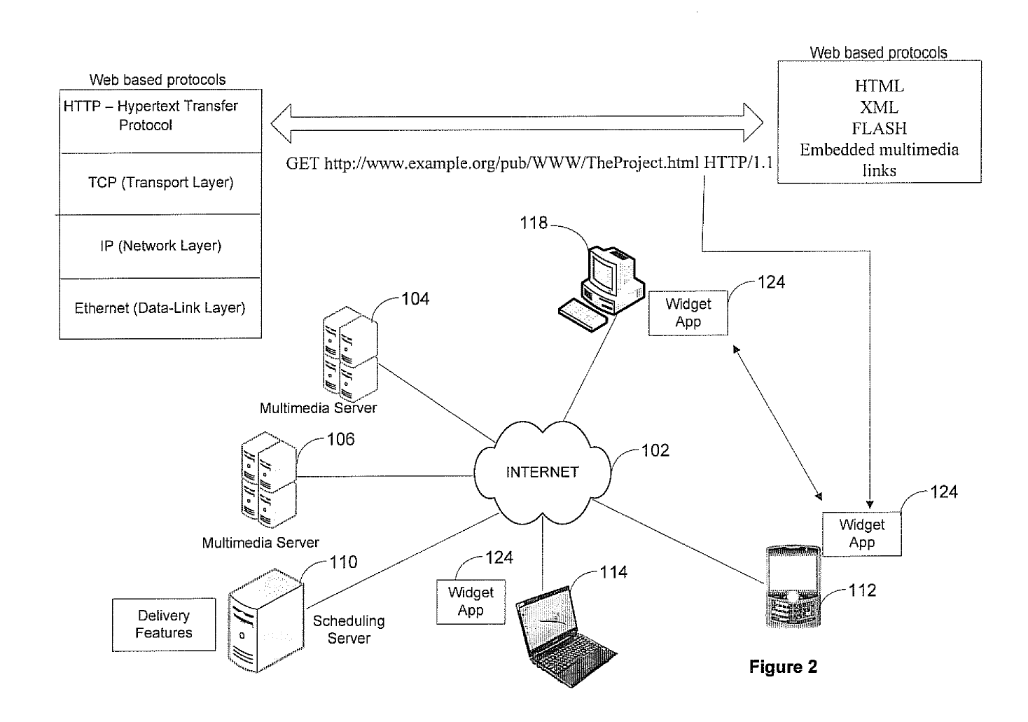

FIG. 2 illustrates the use of a software widget 124 on a smart phone 112 with cellular wireless access. The widget 124 can be installed on any Internet-connected device, such as a desktop computer, a wireless-enabled laptop, or a smart phone. Through the use of the above widget 124, whenever a user makes a request with their Internet-connected device for multimedia content, the widget 124 searches a current website for multimedia files by searching for and capturing get commands associated with particular multimedia files. Searching for the get commands can enable the widget 124 to acquire a complete address of a discovered audio/video files. In other words, when the wireless device requests data from the internet, the widget 124 can make a copy of any discovered get command addresses. In one embodiment, the discovered audio/video files may be directly accessed through the widget 124.

In other embodiments, the widget 124 can also scan through a particular webpage and find and record the get command addresses of all audio/video files on the webpage. For example, when an audio or video file can be accessed from a website, the widget 124 can find and capture the get command for any multimedia file that is requested. This recorded get command can then be sent to the scheduling server 110. In one embodiment, the widget 124 communicates with the scheduling server 110 and the widget 124 is able to search on the scheduling server 110 for previously recorded “get” commands for previously discovered multimedia content.

In an exemplary embodiment, when a user searches for a particular audio or video file, the widget 124 will record the get commands for all multimedia content that is found. In other words, all of the multimedia files on the webpage searched by the widget 124 will have their get commands recorded by the widget 124 and sent to the scheduling server 110. This allows a widget 124 to request a particular selection of multimedia that was previously discovered and its get command captured, which is then retrieved by the scheduling server 110, where a proxy is created and the requested multimedia content is streamed to the destination device for play back by any multimedia player. In other words, the multimedia content itself isn't downloaded to the scheduling server 124, just the URL address (or virtual link) for the saved multimedia files which can then be accessed by the widget 124 and streamed for playback by the multimedia player.

One benefit of using the scheduling service implemented with the scheduling server 110 for scheduling the streaming of multimedia content is the ability to avoid having to host the multimedia content itself. The routing of the multimedia file to the widget 124 is controlled by the scheduling server 110. Therefore in one exemplary embodiment, on a later date and/or time, a user must only search the scheduling server 110 through the widget 124 to find the multimedia content that was previous discovered. As discussed above and below, a particular multimedia content can also be scheduled for streaming at a later date and time as recorded in a calendar of the scheduling service.

In one embodiment, the recorded “get” commands for multimedia files can be transferred between two different widgets 124. In this embodiment, the widget app 124 on the edge device 118 is associated with a first user with a unique user name and password while the widget 124 on the smart phone 112 is associated with a second user with a different unique user name and password. In other words, after the completion of a search of a webpage or a search of several webpages for “get” commands for multimedia content, a selection of recorded get commands can be transferred from one user's widget 124 to another user's widget so that the second user is not required to complete the same search. While the search for the “get” commands will return all multimedia files that are associated with the “get” commands, just a portion of the discovered “get” commands can be saved or transferred between different widgets 124.

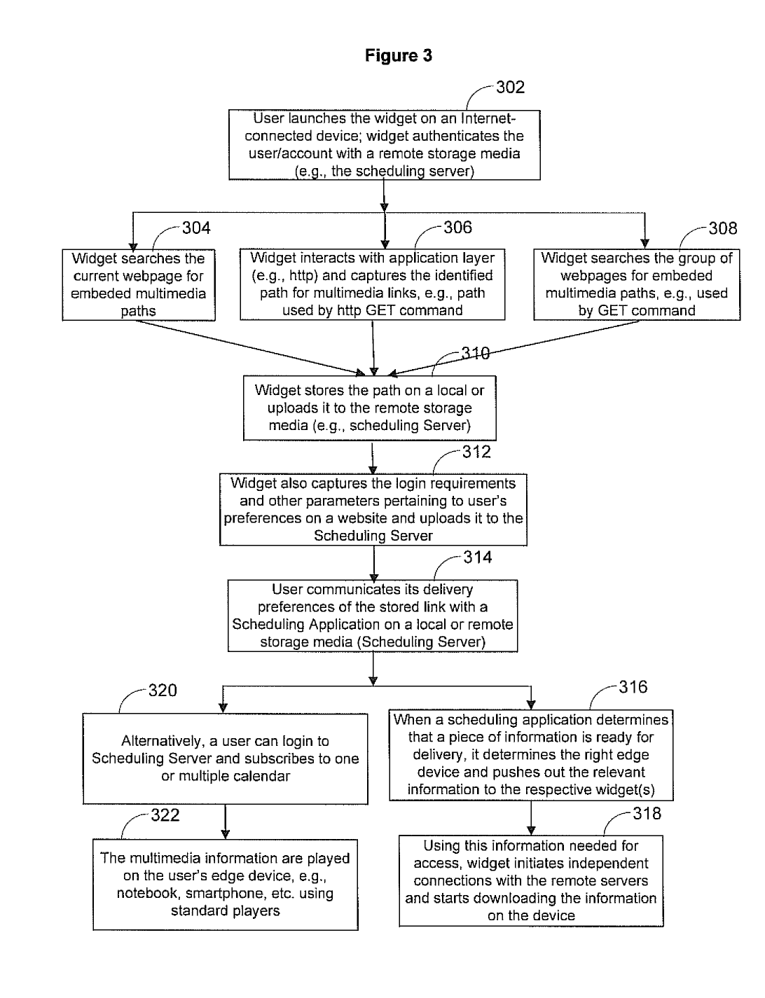

FIG. 3 illustrates the steps to a process for using a widget 124 to scan webpages for multimedia contents and record the get commands (URL addresses or virtual paths) for the discovered multimedia content. In step 302 of FIG. 3, a user launches a widget 124 on any Internet-connected device (such as a smart phone 112 or laptop 114). The widget 124 authenticates the user's password information or account information with a remote storage media (e.g., the Scheduling Server 110). Each user can be assigned a particular account that when accessed by a widget 124 allows access to the saved virtual links or URL addresses recorded previously, as well as access to any calendars that have date/time's saved for the streamed delivery of desired multimedia content.

In steps 304-308 of FIG. 3, the widget 124 searches a current webpage for any embedded multimedia paths. In searching a current webpage, the widget 124 can search an opened webpage in a web browser for the “get” commands for multimedia files. In one embodiment, the widget 124 can interact with an application layer (e.g., http) and capture the identified virtual path or URL address for multimedia links, e.g., the paths used by the http “get” commands. In one embodiment, the widget 124 searches a group of webpages for embedded multimedia paths, e.g., used by the “get” command.

In step 310 of FIG. 3, the widget 124 stores the virtual path to a multimedia file on a local drive or uploads the virtual path to a remote storage server, e.g., the scheduling server 110. In step 312 of FIG. 3, the widget 124 also captures any required login requirements and other parameters pertaining to a user's preferences on the particular website and uploads them to the scheduling server 110 as well.

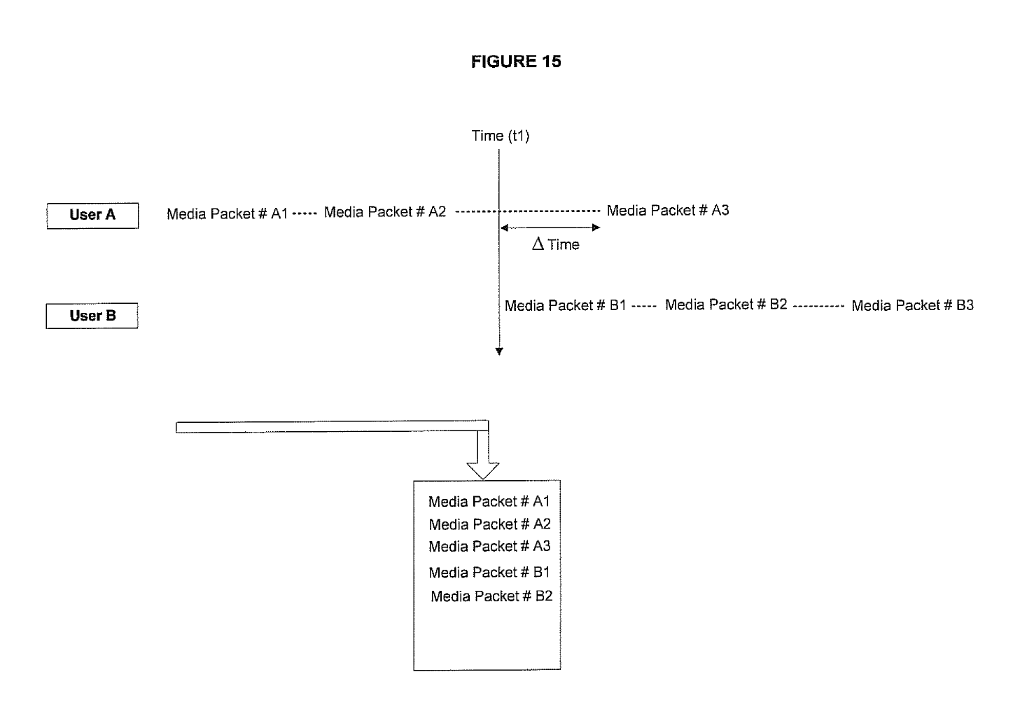

In step 314 of FIG. 3, the user communicates delivery preferences of the stored virtual link with a scheduling application (e.g., one or more calendars) on the local drive in the internet-connected device, or on the remote storage server (e.g., scheduling server 110). The widget 124 can add a selected or identified piece of multimedia content to be sent to the destination device (the device that accesses the calendar (activating it)) on a particular date/time. The use of such a calendar is further illustrated in FIG. 15. Such a calendar or scheduling application can allow the scheduling of multimedia content for delivery to at least a single destination device. Such scheduling can allow the development of a lineup of multimedia content scheduled to be streamed on a particular date and time, each portion of the multimedia content having a separate scheduled date/time and duration. Such scheduled “programming” can be sent to one or a plurality of different destination devices.

In step 316 of FIG. 3, when the scheduling application or calendar determines that a particular portion of multimedia content is ready for delivery, the calendar determines the right Internet-connected device with the right widget 124 (e.g., the correct users) and pushes out the relevant information to the respective widgets 124. In step 318 of FIG. 3, using this information needed for access, the widget 124 receiving the information initiates independent connections with the remote servers and starts downloading the information on the device. As the multimedia content is streamed from the source multimedia server to the widget 124, a standard multimedia player on the Internet-connected destination device begins playing the streaming multimedia content.

In step 320 of FIG. 3, a user can login (using an Internet-connected device) to the multimedia content scheduling service (e.g., the scheduling server 110) and subscribe to one or more calendars in the scheduling application. In such an embodiment, a widget 124 does not have to be present on the Internet-connected device used to login to the calendar(s). In step 322, when a user has logged onto a subscribed calendar (e.g., logging into a calendar makes that calendar “active”), the multimedia content scheduled for a particular date/time is played on the user's Internet-connected device using standard multimedia players at the scheduled date/time. In one embodiment, one desiring particular multimedia content can subscribe to one or more calendars and receive the scheduled content from the one or more calendars when they are opened (e.g., activated). In one embodiment, a subscriber can be one who has received an invitation to view the calendar, with a virtual path to the calendar included in the invitation.

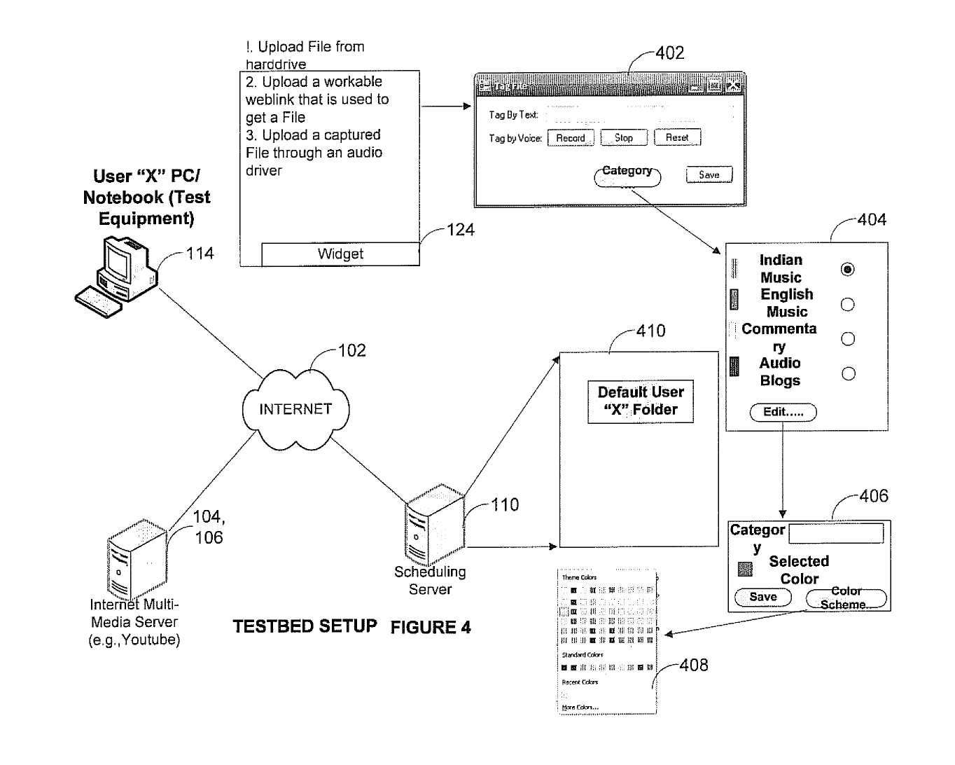

FIG. 4 illustrates the customization of the contents of a calendar, as further illustrated in FIG. 15. FIG. 4 illustrates the selection, creation and editing of categories for multimedia contents that are placed into a calendar for scheduled delivery by the scheduling server 110 to at least a single destination device at a selected date and time. Further, the multimedia files scheduled into a calendar can also be sent to other users so that it is also saved into their calendars as well. In one exemplary embodiment, a user “X” can be logged into the Scheduling server 110 via an Internet-connected device, such as a computer 114. Using the widget 124 on the computer 114, categories can be selected or created in the module 402 accessible in the widget 124. Categories can be selected, edited or added in the category module 404 as illustrated in FIG. 4. Furthermore, as illustrated in FIG. 4, the categories can be edited in the editing module 406, including the selection of a color scheme in the color scheme module 408. As illustrated in FIG. 4, each user has a default folder 410 for storing recorded virtual paths and other content that can be edited and added to as discussed herein.

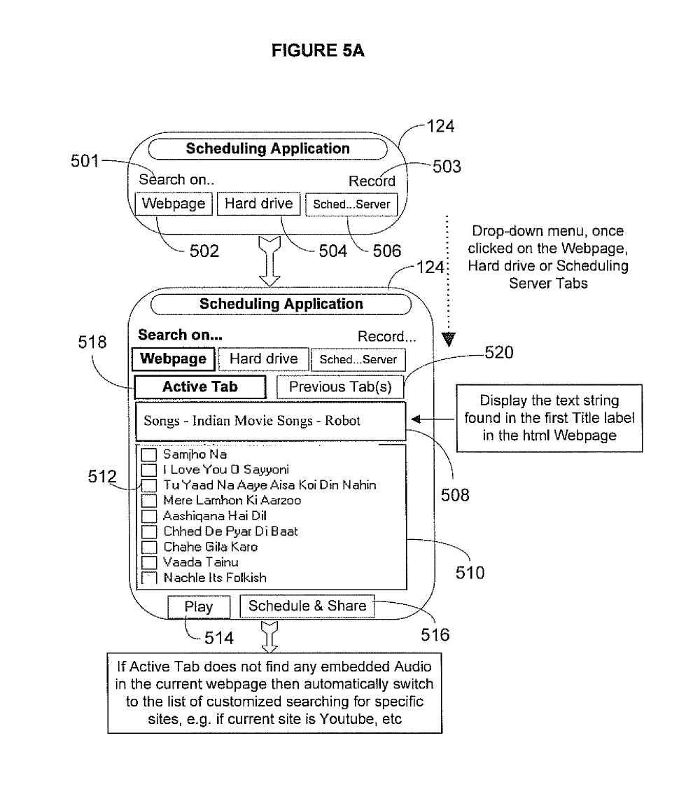

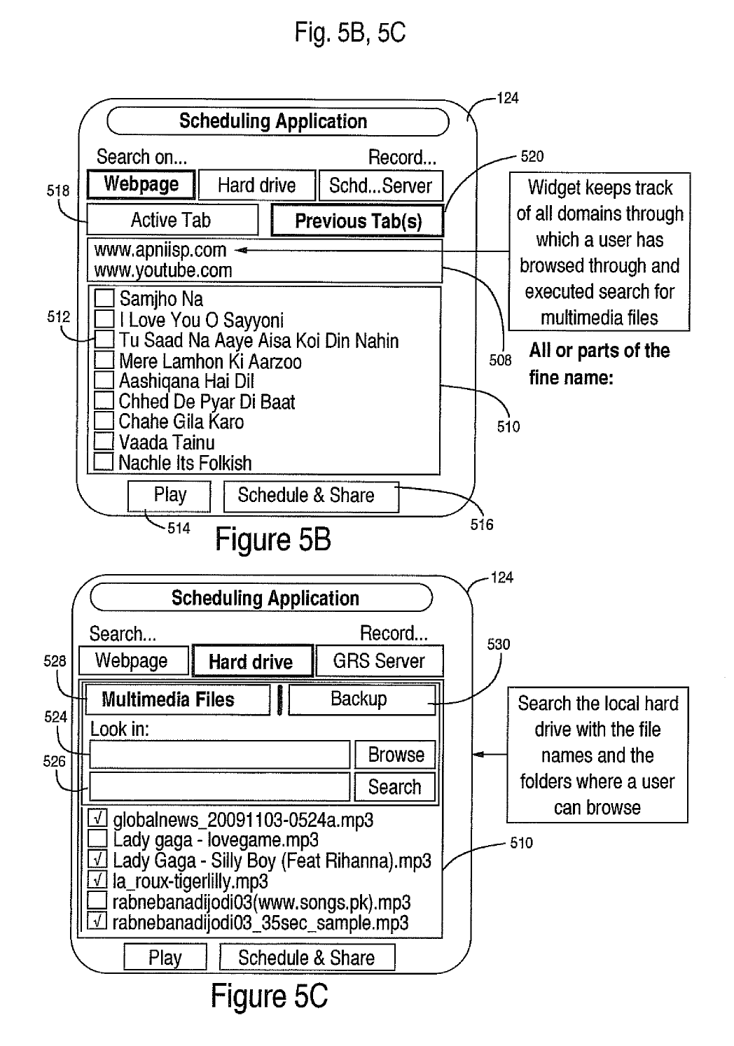

FIG. 5A illustrates an embodiment of a widget 124. As illustrated in FIG. 5A, the widget 124 can be commanded to search for multimedia contents either on a webpage, a local hard drive, or the GRS server, by selecting a webpage search 502, a hard drive search 504, or a search 506 on the Scheduling server 110, respectively. As illustrated in FIG. 5A, the widget 124 can be selected to perform a Search 501 or Record 503. As illustrated in FIG. 5, a widget 124 can include a Title drop box 508 displaying a text string found in the first Title label contained in the html source code for the webpage. The widget 124 can also include a Search Results drop box 510 that contains the names all of the multimedia files that have been located on the webpage. AS discussed above and below, the multimedia files are detected by searching for “get” commands associated with the. As also illustrated in FIG. 5, embodiments also include check-boxes 512 allowing a particular multimedia content to be “selected” for later playback, to be shared with other users, or to be scheduled in the scheduling application (e.g., placed into a calendar). The radio-button “Play” 514 directs the widget 124 to initiate the streaming of the selected multimedia file from its source (e.g., the multimedia server, or local drive where it is located). The radio-button “Schedule & Share” 516 enables the widget to initiate the scheduling of the selected multimedia selections in one or more calendars, as discussed below, or the sharing of the virtual links or URL addresses of the selected multimedia selections. In one embodiment, if the webpage does not find any embedded audio or video files in the current webpage, then the widget 124 can switch to a list of customized searches for specific site, e.g., if the current site is youtube.com, for example. As illustrated in FIG. 5, the radio-button “Active Tab” 518 displays the current webpage search, while the radio-button “Previous Tab(s)” 520 displays all previous webpage searches. When the Previous Tab 520 radio button is selected, all previous searches will be displayed in the Title drop box 508 and are individually selectable to display the associated search results in the Search Results drop box 510.

FIG. 5B illustrates the viewing of previous search results in the widget 124, as discussed above. For example, in FIG. 5B, the Previous Tab(s) radio button is selected, so the Title drop-box is displayed, containing a list of all the domains through which a user has previously browsed and executed searches for multimedia files. As illustrated in FIG. 5B, the Search Results drop-box 510 is also revealed, displaying a list of all the multimedia files that were discovered in the previous searches. As illustrated in FIG. 5B, the search results from different domains (webpages) can be separated and individually accessed, by placing them into multiple folders.

FIG. 5C illustrates the viewing of search results when a hard drive is searched by the widget 124. As illustrated in FIG. 5C, the “Hard drive” radio button 504 is selected. Selecting the “Hard drive” 504 radio button and the “Multimedia Files” 528 radio-button results in the appearance of the Search Results drop-box 510 with the results of the Hard Drive search. The HDD Search Results drop box 510 for the Hard drive search includes input fields for selection criteria (e.g., a particular folder and search terms) for a search function. Further, the hard drive can also be browsed, rather than searched. The File Path input box 524 provides for the selection of a folder in the target hard drive. Further, the Search Terms input box 526 provides for the input of terms for the generation of a query to be performed during the search. As further illustrated in FIG. 5C, the search results can be displayed in the Search Results drop box 510, with the results individually selectable, by selecting corresponding check-boxes 512. Again, the results of the Hard driver Search or the results from Previous Tabs 520, can be played, scheduled for later playback, or shared with other users by placing them into their public folder as discussed below.

As illustrated in FIGS. 5D and 5E, embodiments of the widget 124 can also perform a backup function. In one exemplary embodiment, the backup functionality is initiated by “clicking” a “Backup” radio-button 530 after the Hard drive 504 radio button has been selected. Similar to the search function, the File Path input box 524 allows the selection of a folder in the target hard drive. Further, the Search Terms input box 526 is for the input of terms for the generation of a query to be performed during the search. The Search Results 510 can also be selected individually by checking their corresponding check-box 512. As illustrated in FIG. 5E, embodiments of the backup function can also display files that are currently backed up a Backup Files panel 532, as well as a Not Backed Up panel 534 that can display those identified files that have not yet been backed up.

Once a file has been saved to the Scheduling server 110, the widget 124 can send a new copy of the file to the Scheduling server 110 whenever it detects a change. In one embodiment, the widget 124 can send files for backup to the Scheduling server 110 when there is available internet usage. In other words, when there is other Internet usage that is reducing the available bandwidth, those files selected for backup can be held back from transfer to the Scheduling server 110 until the available bandwidth increases.

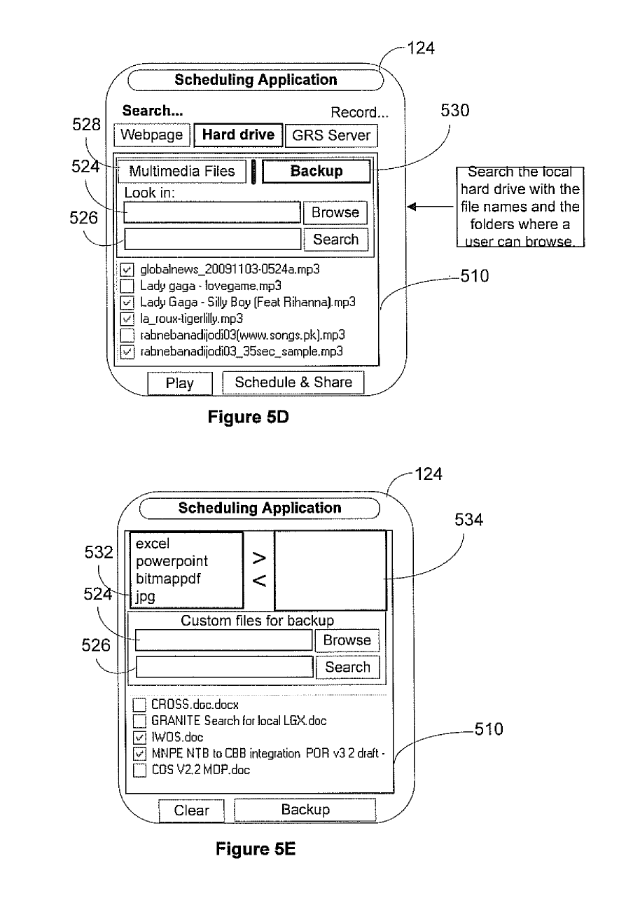

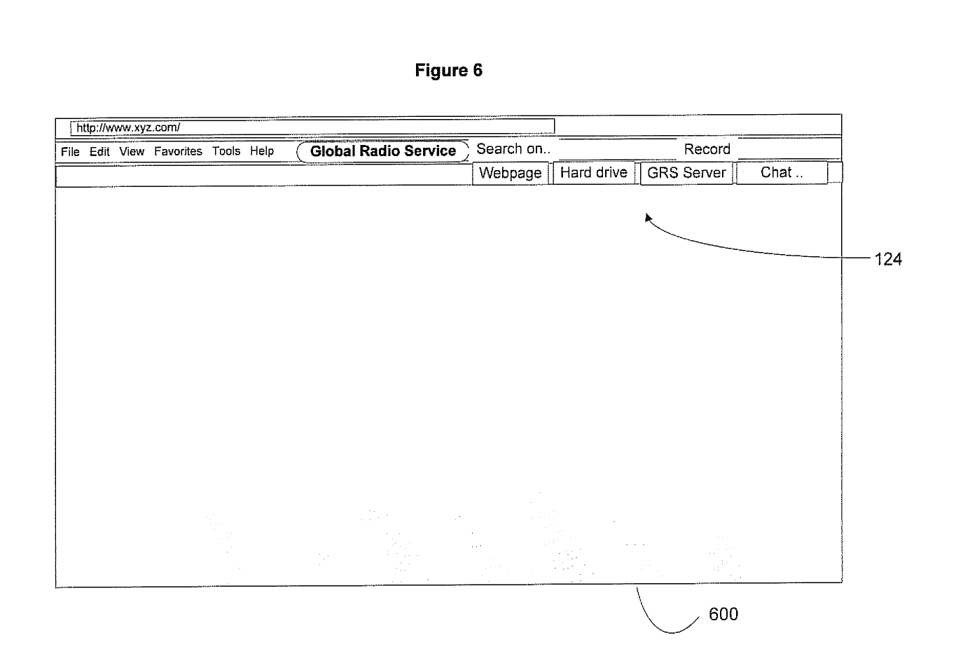

FIG. 6 illustrates that the widget 124 as illustrated in FIGS. 5A-5E may also be embedded into a webpage displayed in a web browser 600. In other words, rather than a separate widget 124 that can be “pinned” to the top of a desktop so that it rises above any open webpages, the widget 124 can also be found within the open webpage 600, as illustrated in FIG. 6. The embedded widget 124 illustrated in FIG. 6, is the widget 124 of FIG. 5 without any of the drop boxes displayed (e.g., the Title drop-box 508 and Search Results drop-box 510 are not currently displayed).

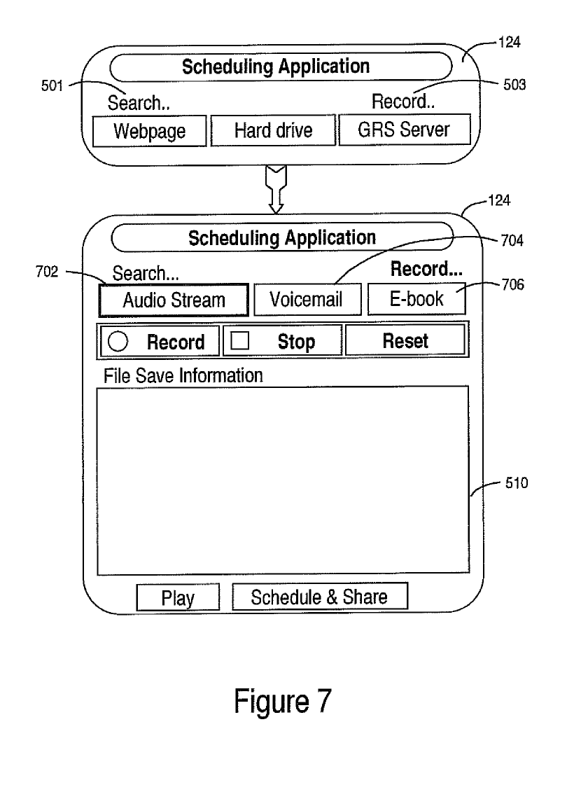

As illustrated in FIG. 7, the widget 124 also provides the ability to create a voicemail file using standard commands, such as “record,” “stop,” and “reset,” as well as schedule a time for the file to be sent on to a destination device. A voice mail recording can be created by selecting “Record” 503 on the widget. With Record 503 selected, the “Record” label will be highlighted and the Record functionality drop boxes will appear, as illustrated in FIG. 7.

In other embodiments, as illustrated in FIG. 7, audio streams 702, voicemail (e.g. a voice email) 704 and e-books 706 can be selected by their corresponding radio-button illustrated in FIG. 7. Such recordings may be created and then transmitted on to a destination device after being scheduled in a calendar as discussed below. In one embodiment, the destination device need not have the widget 124 installed to receive the recorded file.

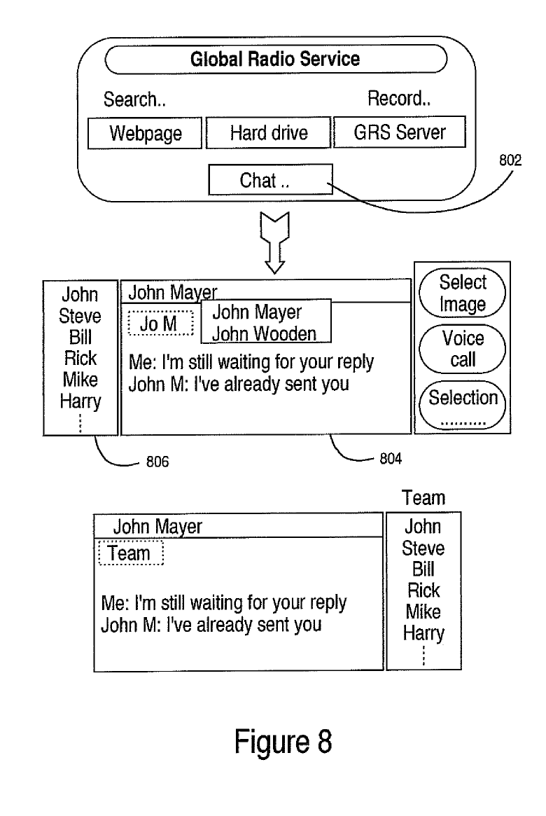

In embodiments illustrated in FIGS. 8-10, a Chat function is added to the Widget 124. As illustrated in FIG. 8, chat functionality may be accessed by selecting the “Chat” 802 radio button. As also illustrated in FIG. 8, when the chat functionality in an exemplary widget 124 is selected by selecting the Chat 802 radio button, the chat window 804 will be displayed. FIG. 8 illustrates an exemplary group chat function in the widget 124 that intelligently sorts previously contacted users such that the users that are connected the most frequently are at the top of the list 806. Such embodiments allow the user to efficiently initiate communications through the chat functionality 804 with desired users by sorting the list of chat users 806 according to frequency of previous contacts.

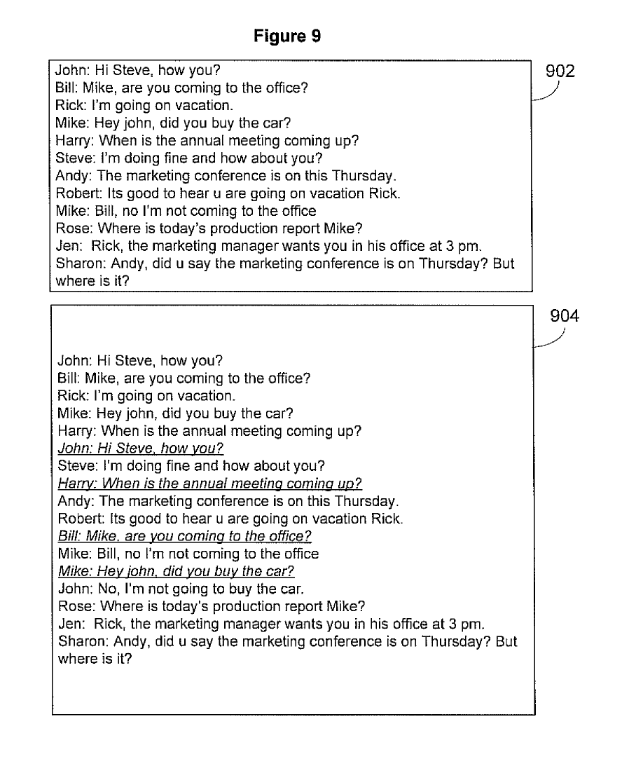

FIG. 9 illustrates an exemplary embodiment of the chat functionality in the widget 124 that links individual chat messages with their corresponding replies. As illustrated in the exemplary conventional chat window 902, the chat messages are scattered and it is not always easy to determine what message goes with what reply. However, as illustrated in the bottom chat window 904, exemplary embodiments of the present invention can include functionality that can link an initial message with its reply. As illustrated in the bottom chat window 904, when a chat user initiates a reply to a chat message, an underlined repeat of the original message can be posted along with its associated reply immediately thereafter.

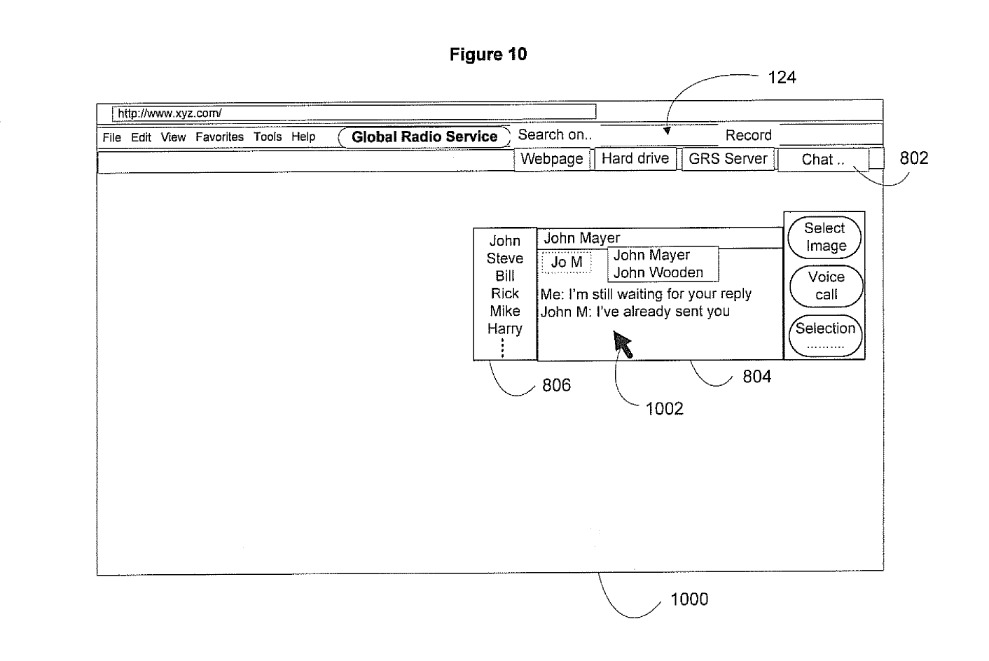

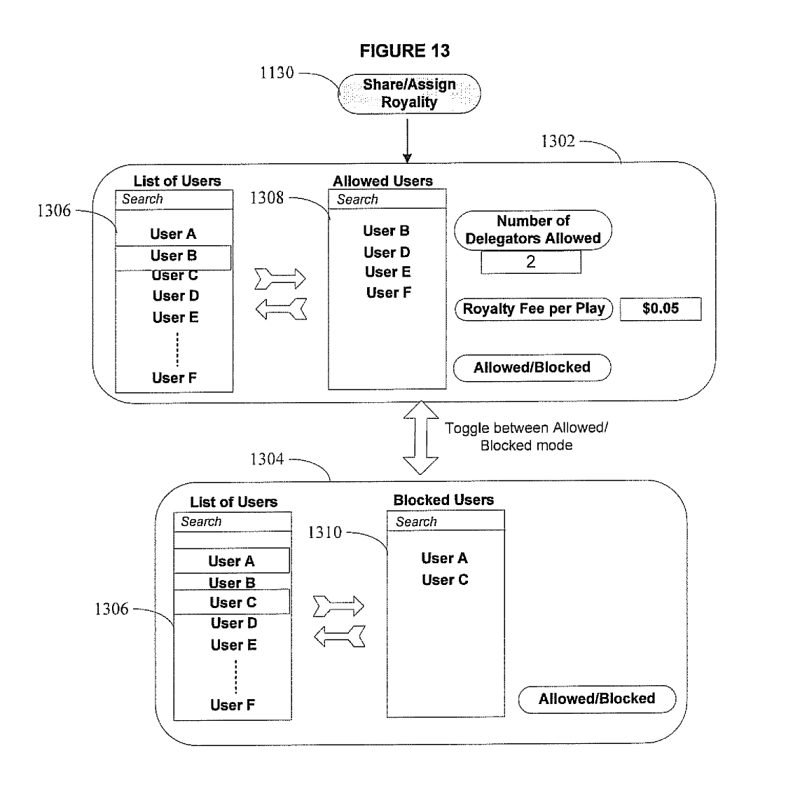

FIG. 10 illustrates an embodiment of the chat function that is embedded in a web browser 1000, similar to embodiments illustrated in FIG. 6. When the chat functionality is selected by selecting the Chat 802 radio button on the web browser, the chat window 804 with user list 806 is displayed below the embedded widget 124. In one embodiment, when the chat window 804 is open but idle, it will fade into the background (e.g., becoming transparent) such that it will not be a distraction while the user is doing something else, such as working on a document or surfing the Internet. However, when the user places a mouse curser 1002 over the group chat window 804, as illustrated in FIG. 13, the group chat window 804 comes into the foreground and is easily viewed. In one exemplary embodiment, two or more users using the scheduling service chat functionality through the widget 124 while in web browsers 1000 can be on the same webpage by dynamically synchronizing the webpages of the user(s) responding to the chat message sent by the initiator. For example, when a chat message is sent, the sending user's widget 124 can send a virtual link to the sender(s)' current webpage so that the receiving user's widget 124 can optionally direct the receiving user's browser to load the directed webpage.

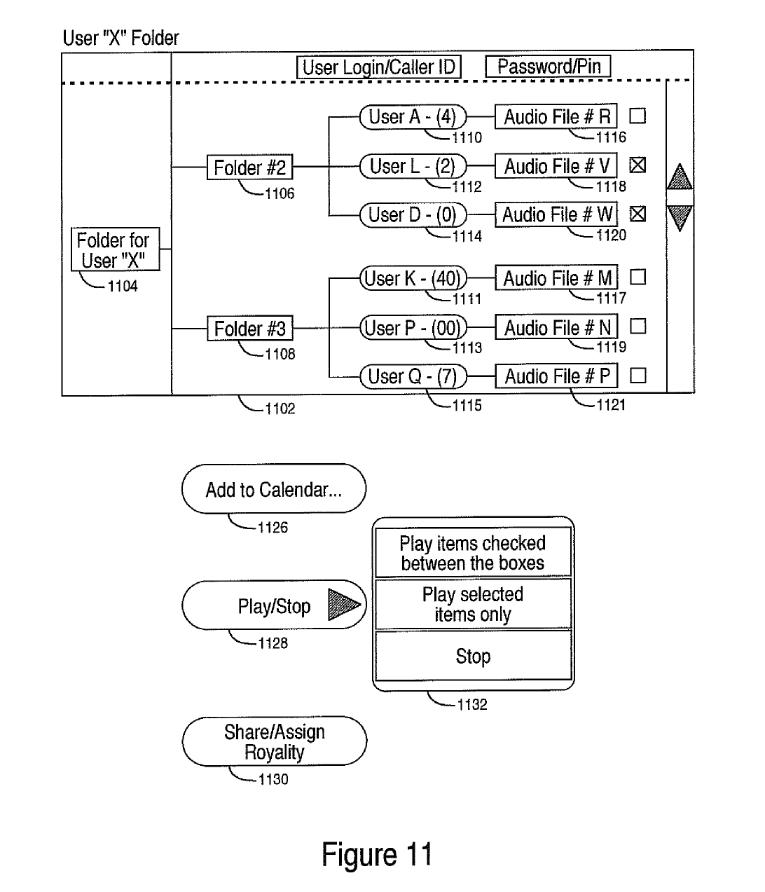

FIG. 11 illustrates an exemplary folder hierarchy for a particular user “X” of the scheduling service. In one embodiment, each user can have a “root” folder (with a plurality of folders within the root folder) stored within the Scheduling Server 110. By logging into the Scheduling Server 110 a user can access their folder and any sub-folders that have been created. In one embodiment, a user can access the scheduling server 110 through a website portal. In one embodiment, when a new user account is established, the new user is assigned a user name/password combination. As discussed above, while access to the scheduling server 110 (through the Internet portal) and the widget 124, as discussed herein, requires a user account, a calendar (for access to scheduled multimedia content) can be accessed and activated without a user account. In other words, accessing a calendar (and receiving its scheduled streaming multimedia content) through its virtual link to its Internet portal in the scheduling application does not require access to the scheduling server 110 or a widget 124. As discussed in detail below, in exemplary embodiments access to a calendar can require a password to access the scheduled multimedia content. In such an embodiment, the password is provided by the creator of the calendar and provided to all subscribers.

As illustrated in FIG. 11, in one exemplary embodiment, a user's folder hierarchy can be displayed in a file sharing control screen 1102. Exemplary user “X” has a root folder 1104 with other exemplary sub-folders 1106, 1108 found within it. As further illustrated in FIG. 11, a sub-folder #2 1106 can contain sub-folders 1110-1114 for associated users (User A, User L, and User D). As illustrated in FIG. 11, each user fold (1100-1115) contains multimedia content 1116-1121. For the sake of clarity and ease of illustration, only a single audio file is associated with each user folder 1110-1115, however, any combination of multimedia content can be associated with a user. Therefore, embodiments of the present invention allows the creation of a system for organizing and coordinating the rights that a user (User A, User L, and User D, etc.) has and whether or not they (User A, User L, and User D) will be able to share a particular multimedia file with other users. In one exemplary embodiment, the multimedia content 1116-1121 found in a user's sub-folder 1110-1115 can be shared with another user.

In one embodiment, when accessing the file sharing control screen 1102, the user “X” also can edit user name/password combinations. Such user name and password combinations can be edited for User X. As also illustrated in FIG. 11, the file sharing control screen also contains radio buttons that allow a selected multimedia content to be added to a Calendar, played in a media player, or assigned a royalty when the selected multimedia content is user created content. As illustrated in FIG. 11, when the Play/Stop 1128 radio button is selected, a control box 1132 is displayed. The control box 1132 allows the user to play items selected or stop playback. As discussed in detail below, when the “Add to Calendar” 1126 radio button is selected, a Calendar is opened and the selected multimedia content is added to the Calendar. When the “Share/Assign Royalty” 1130 radio button is selected, a royalty can be selected for the selected multimedia content, as discussed below. When the Share/Assign Royalty 1130 radio button is selected, the sharing rights of users can be established as discussed below.

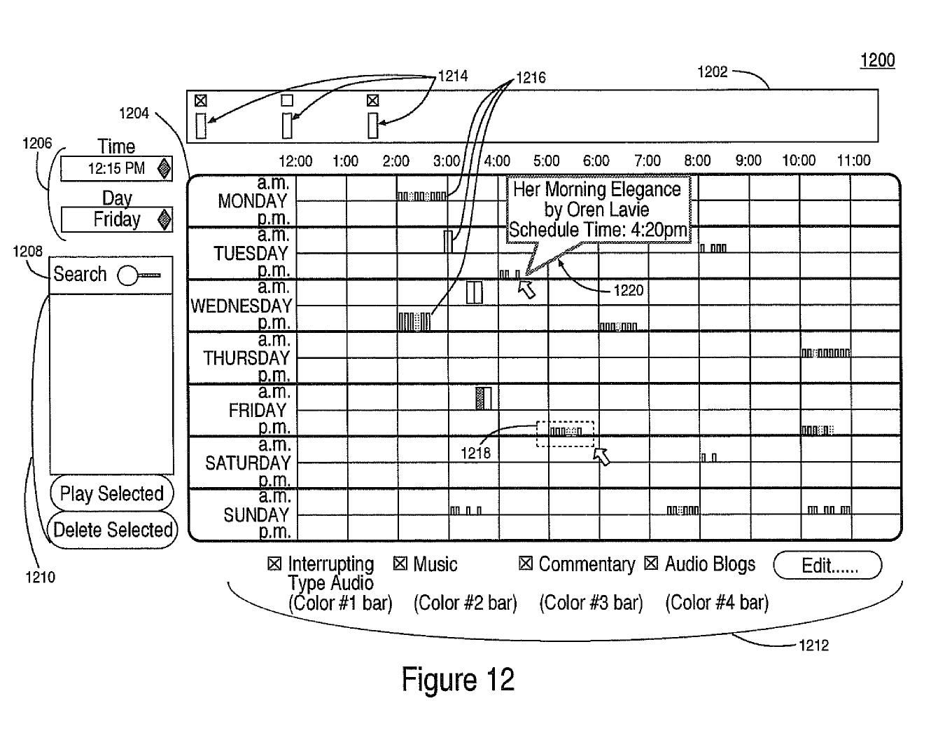

FIG. 12 illustrates an exemplary calendar 1200 created by the scheduling application in the scheduling server 110. In one embodiment, the calendars 1200 for a user are accessed through a Internet portal, similar to the accessing of the folders through the Scheduling server 110 as discussed above. In one embodiment, a user can have one or more calendars. As discussed herein, a user's calendar 1200 can be selected as public or private. A public calendar is available for access by others to receive any scheduled multimedia content contained in the public calendar, while a private calendar is only available for access by others who have been granted access to the folder it is stored in. In one exemplary embodiment, a calendar can also be created that requires a password to access, so that those with access to the calendar through the Internet portal still have to enter a password to access the calendar and activate it.

In one exemplary embodiment, a calendar 1200 can only be edited by the user. Others who are accessing the calendar (whether public or private with password access) are only able to select multimedia content in the open calendar for immediate streaming or can receive the streaming multimedia content according to the scheduled date/time for the multimedia content. In one exemplary embodiment, a particular calendar 1200 is “active” when the calendar 1200 in question has been opened on a webpage (e.g., Internet portal). Only active calendars 1200 are able to stream their scheduled multimedia content to a media viewer/player. In other words, if a calendar 1200 has not been opened (the virtual link to the calendar 1200 followed in a web browser), then any scheduled content will not being streaming, even if the date and time for such streaming has been reached.

As illustrated in FIG. 12, an exemplary calendar 1200 comprises a launch pad 1202, a scheduler 1204, a date and time 1206, a search panel 1208, a selection panel 1210, and scheduler editing tools 1212. When a multimedia content (a music video, streaming audio, live streaming news cast, or movie, for example) has been selected to be saved into a calendar 1200 for streaming delivery at a scheduled date and time, the selected multimedia content is placed in the launch pad 1202 of a Calendar 1200.

In the launch pad 1202 illustrated in FIG. 12, three exemplary multimedia selections 1214 have been added to the calendar 1200 for scheduling. By dragging and dropping the multimedia selections 1214 into the scheduler 1204, or by clicking on the check-box with each multimedia selection 1214, the checked multimedia selections 1214 can be added to the scheduler 1204. In one embodiment, time blocks 1216 are used to fill a scheduler 1204. Each time block 1216 is a scheduled amount of time that a selected multimedia content will be streamed, with the time block 1216 visually indicating the scheduled date and time for streaming. In one embodiment, as illustrated in FIG. 12, a calendar's 1200 scheduler 1204 can be divided into seven days, with each day divided into two 12 hour days. The date and time 1206 as illustrated in FIG. 12, can show the current date and time, as well as selecting a particular length of time for display in the scheduler.

In one embodiment, as illustrated in FIG. 12, with a large collection of time blocks placed end-to-end, a full schedule of “programming” can be creating, such that a selected collection of multimedia content will be streamed according to a selected schedule. In one embodiment, when a multimedia content is selected and placed into the launch pad 1202, an amount of time can also be selected. For example, while a selected multimedia content may be two hours in length, only the last thirty minutes of it may have been selected, such that only a thirty minute block of time 1216 will appear in the calendar 1200 when the selected multimedia content 1214 is scheduled. In one embodiment, a selected multimedia content 1214 can be placed into one or more time blocks 1216. A collection of time blocks 1216 can be selected at the same time, as illustrated in FIG. 12. In one embodiment, a pointer can be used to drag a box around a collection of time blocks 1216, as illustrated in FIG. 12. A pointer can also be used to select or “mouse over” a time block and a popup 1220 can appear stating the multimedia content's title and scheduled time for streaming. Therefore, in one exemplary embodiment, a calendar 1200 can contain a schedule of “programs” such as a plurality of music videos to be individually streamed from www.youtube.com, followed by an hour of a streaming news cast from a streaming news website, followed by several television episodes streamed from hulu.com, all playing consecutively until the string of scheduled multimedia content is complete.

As illustrated in FIG. 12, the Search panel 1208 provides a means for searching for multimedia content in the current calendar 1200. The selection panel 1210, as illustrated in FIG. 12, displays a selected time block 1216 that has been individually clicked on in the scheduler 1204, or found through a search query using the search panel 1208. When the “play selected” radio button is selected, any multimedia titles displayed in the selection panel 1210 can be immediately streamed to a media player for playback. The scheduler editing tools 1212 provide a means for editing the time blocks 1216 such that the time blocks 1216 may be color coded and categorized according to a user's wishes. Such editing functions are only available for the owner of the calendar 1200, therefore, when a calendar 1200 has been opened or activated by someone other than the owner, the editing tools will not be visible.

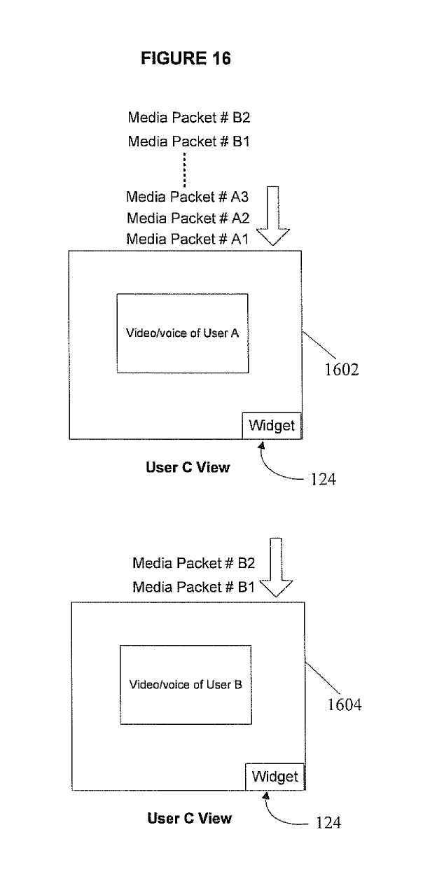

FIG. 13 illustrates the assigning of royalties to songs or other multimedia content when they are played, when the creator of a multimedia file has selected a royalty for each play. The use is for placing in a royalty fee requirement when the owner of a copyrighted multimedia file requires a royalty fee for each download. As also illustrated in FIG. 13, when the “Share/Assign Royalty” 1130 radio button has been selected, the Allow Panel 1302 and alternatively the Block Panel 1304 can be displayed. FIG. 16 illustrates how various users can be permitted access to private folders of another user, while another user can be blocked from accessing the private folders.

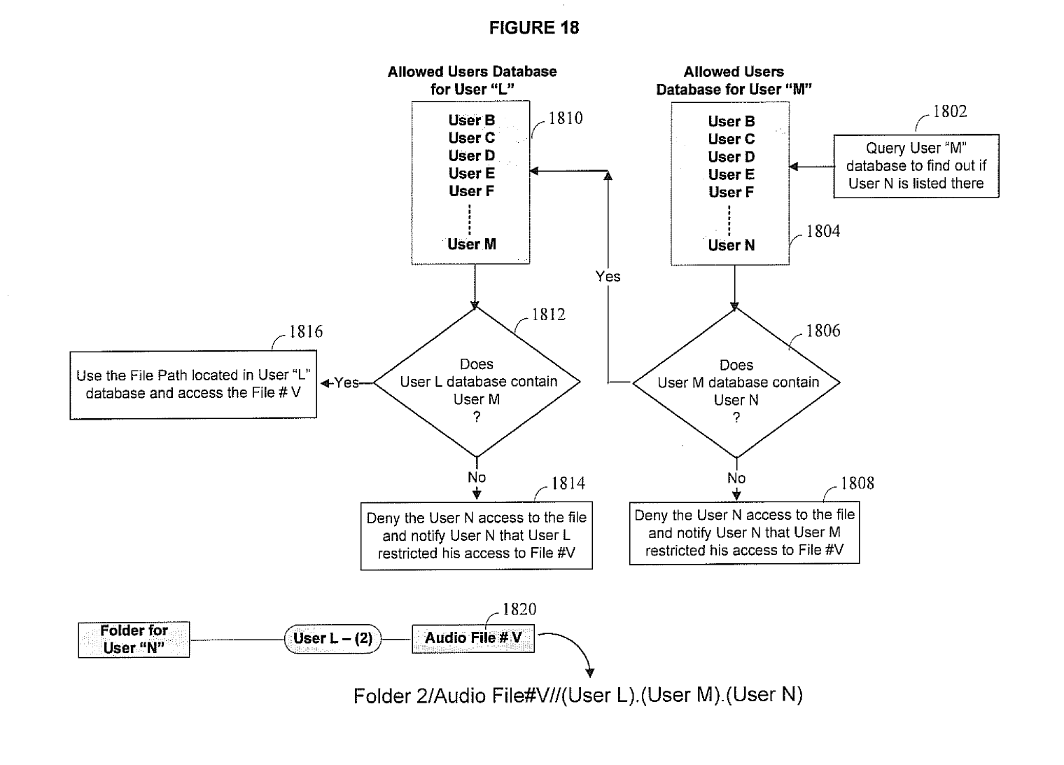

In one embodiment, the multimedia content (e.g., the pointers to their virtual paths or URL addresses) contained in a folder can be shared selectively with other users. As illustrated in FIG. 13, from a list of users 1306, a user can be added to a list of Allowed users 1308, such that those “allowed users” will have access to the folder containing the multimedia content selected, and discussed above and below and illustrated in FIG. 18. Therefore, as also illustrated in FIG. 13, when a user from the list of users 1306 has been added to the Blocked Users 1310, that user will not be able to access the user's private folder and its multimedia content, as discussed below and illustrated in FIG. 18.

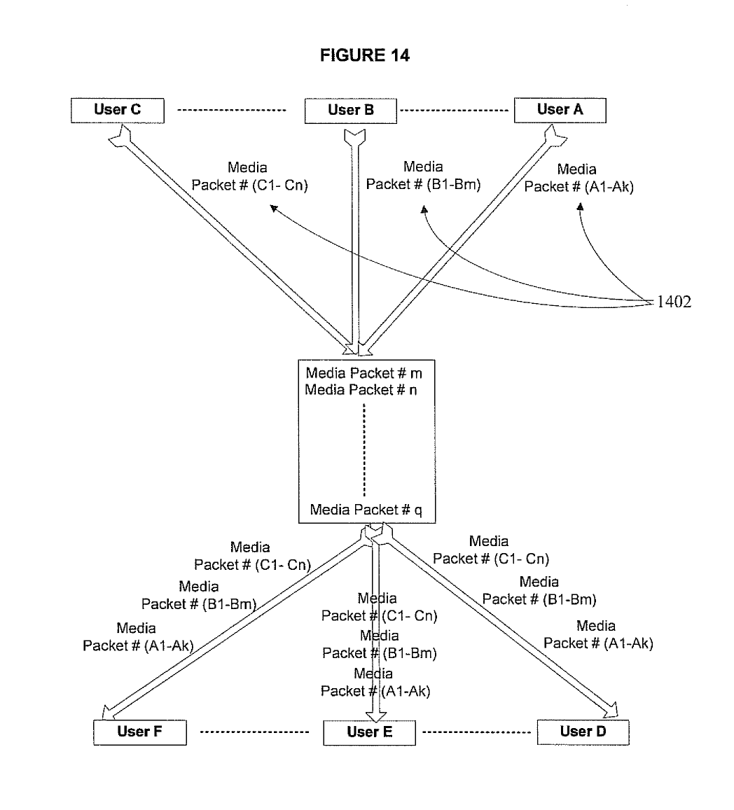

In one embodiment of the present invention, the scheduling service can provide voice chatting, such that a user with a respective widget 124 can voice chat with at least one other user with their corresponding widget 124. As illustrated in FIG. 14, User A, User B, and User C are able to send multimedia packets 1402 to each of the other users in a current chat room. As illustrated in FIGS. 14-16, multimedia packets 1402 sent from one user to be received by at least one other user can be appropriately transferred such that each packet 1402 is transmitted in the order that it was received, without having to deal with multiple files transmitting at the same time, as illustrated in FIG. 16. As illustrated in FIGS. 15 and 16, at time t1, because Media Packet #A2, from User A, is still being transmitted, Media Packet #B1, from User B, which started transmission at Time t1, will not be forwarded to the other users until User A has stopped transmitting. In other words, as illustrated in FIGS. 15 and 16, even though Media Packet #B1, from User B, started transmitting before Media Packet #3, from User A, the Media Packet #B1 will not be transmitted to the other users until after User A has finished transmitting (e.g., there was not a break in transmission between Media Packet #A1, Media Packet #A2 and Media Packet #A3).

Embodiments of the present invention therefore prevent users from talking over each other. Further, embodiments provide for a first-in, first-out audio/video chat. In other words, when user A is speaking, the audio message sent by user B will not be seen or heard until user A's multimedia packet 1402 has finished. This is further illustrated in FIG. 16, where the user currently talking, and at the top of the queue, is the one seen in respective widgets 124 by those receiving the audio/video chat. As illustrated in FIG. 16, the multimedia packets 1402 received by User C from User A and User B will be sorted into the proper order by the widget 124. In one embodiment, as illustrated in FIG. 16, when a multimedia packet 1402 is received by User C from user A, User C's widget 124 can provide a display 1602 that indicates video or voice messages from User A are being received. Therefore, after the multimedia packets 1402 from User A are received by User C, the widget 124 will provide a display 1604 that indicates video or voice messages from User B are being received.

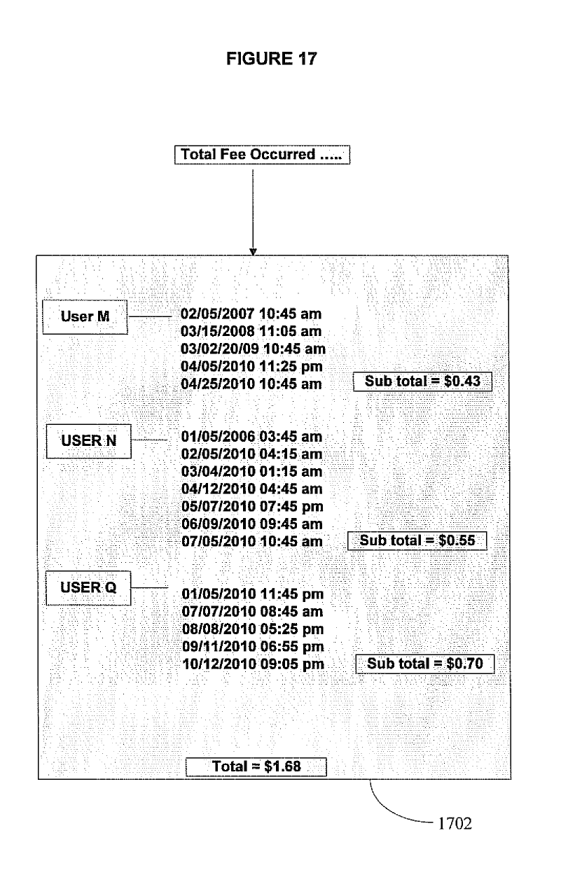

FIG. 17 illustrates the calculation of royalty fees that are collected through the use of playing certain songs, etc. This provides an infrastructure such that a user would be able to assign a royalty fee for a multimedia file that they created and will provide feedback as to who has been downloading the file and the royalty fees that have been charged for such downloading. This can also allow copyrighted materials to be sent through the scheduling server 110, thus ensuring that any royalty fees required are paid by anyone requesting the transmission of those files. As illustrated in FIG. 17, Royalty Fees Panel 1702 displays the date and time that a user received a streaming multimedia content that had a royalty fee associated with it. The Royalty Fees Panel 1702 can also provide a subtotal of the royalty fees paid by each user for receiving a streaming multimedia content that had an associated royalty fee as well as a grand total of all royalty fees received during a given period of time.

FIG. 18 illustrates a flow diagram for a method for accessing a restricted file #V 1820 (e.g., a file or virtual path that is stored in a private folder). In step 1802 of FIG. 18, a query is generated, searching user M's database to determine if User “N” is listed in the Allowed Users data base 1308 of User “M.” In step 1804 of FIG. 18, it is determined whether or not User M's Allowed Users database 1308 contains User N. In step 1806 of FIG. 18, if User M's Allowed Users database 1308 does not contain User N, then User N is denied access to the requested file and User N is notified that User M has restricted access to the desired File #V 1820. In step 1810 of FIG. 18, if User M's Allowed Users database 1308 does contain User N, then a query is generated in step 1810, searching user L's database to determine if User N is listed in the Allowed Users database 1308 of User L. In step 1812 of FIG. 18, it is determined whether or not User L's Allowed Users database 1308 contains User N. In step 1814 of FIG. 18, if User L's Allowed Users database 1308 does not contain User N, then user N is denied access to the requested file (audio file #V 1820) and User N is notified that User L has restricted access to the desired file #V 1820. In step 1816 of FIG. 18, if User L's Allowed Users database 1308 does contain User N, then the file path located in User L's database is used to access File #V 1820. In one embodiment, an “Allowed Users” database can be created for each sub-folder in the private folder. In another embodiment, an “allowed user” database can be created for each file or virtual path found in selected private folders.

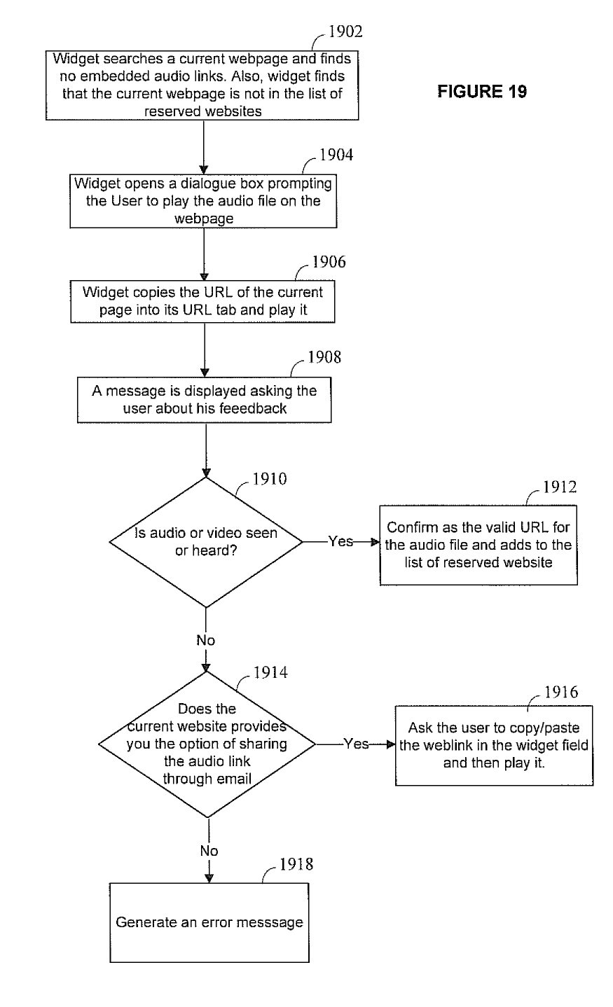

FIG. 19 illustrates a flow diagram for performing searches for multimedia content in webpages. In step 1902 of FIG. 19, a widget 124 searches a current webpage and finds no embedded multimedia links. Furthermore, in Step 1902, the widget determines that the current webpage is not in a list of “reserved websites.” In step 1904 of FIG. 19, the widget 124 opens a dialogue box prompting a user to play what might be an audio or video file discovered in the webpage. In step 1906 of FIG. 19, the widget 124 copies the URL of the discovered potential multimedia file into the current URL tab and plays the selected audio or video file. In step 1908 of FIG. 19, a message is displayed to the user seeking feedback about the playing audio or video. In step 1910 of FIG. 19, it is determined whether or not audio or video has been seen or heard in step 1908. If audio or video has been seen or heard in step 1910, then in step 1912 of FIG. 19, the URL address for the audio or video file is confirmed as valid and the webpage is added to the list of reserved websites. If the audio or video has not been seen or heard in step 1910, then in step 1914 of FIG. 19, a determination is made as to whether or not the current website provides the user with the option of sharing the audio link through email. In step 1916 of FIG. 19, if the current website does provide the user with the option of sharing the audio or video link through email, then the user is asked to copy/paste the virtual path in the widget 124 field and then play it. In step 1918 of FIG. 19, if the current website does not provide the user with the option of sharing the audio or video link through email, an error message is generated.

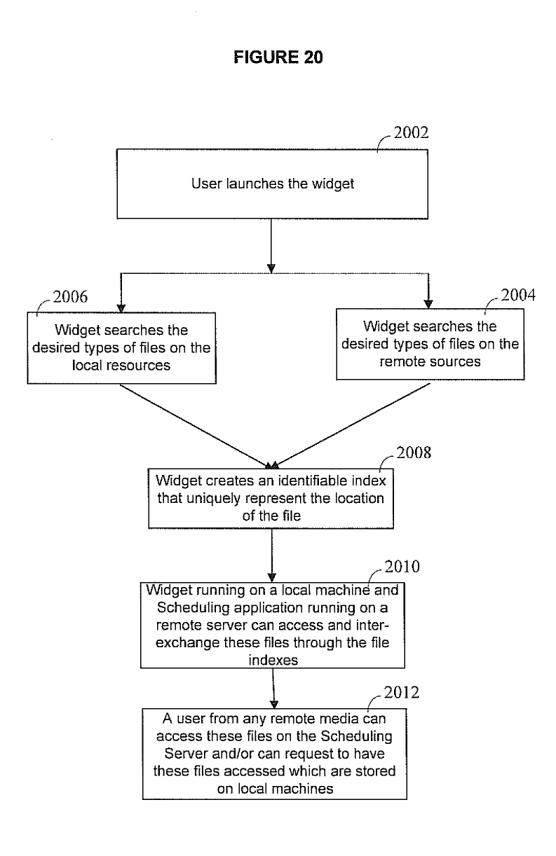

FIG. 20 illustrates a flow diagram for indexing locations of URL addresses for located multimedia content. In step 2002 of FIG. 20, the widget 124 is launched. In step 2004 of FIG. 20, the widget 124 searches for the desired types of files on one or more remote sources (multimedia servers 104, 106). In step 2006 of FIG. 20, the widget 124 searches for the desired types of multimedia files on one or more local resources. In step 2008 of FIG. 20, the widget 124 creates an identifiable index that uniquely represents the location of a multimedia file that is found in steps 2004 and 2006 of FIG. 20. In step 2010 of FIG. 20, the widget 124 running on a local machine and the scheduling application running on the scheduling server 110 can access and inter-exchange these files through the file indexes. In step 2012 of FIG. 20, a user using a widget 124 or through a web browser (e.g., an Internet portal) can access these files on the scheduling server 110 by accessing a calendar associated with the multimedia files and/or can also request to have those files accessed that are stored on local machines.

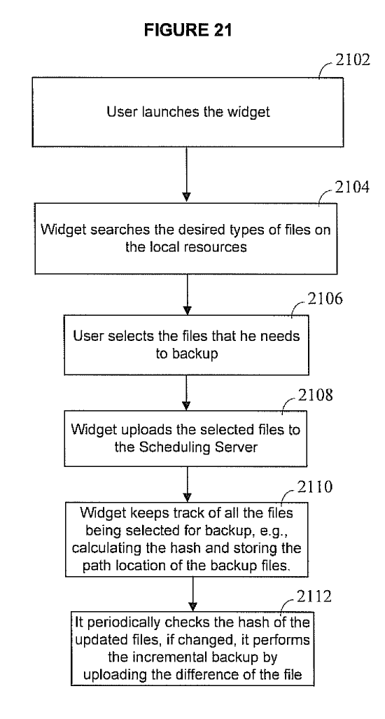

FIG. 21 illustrates a flow diagram for backing up files to the scheduling server. In step 2102 of FIG. 21, a widget 124 is launched. In step 2104 of FIG. 21, the widget 124 searches for desired types of files on one or more local resources. In step 2106 of FIG. 21, one or more of the desired types of files that were found in step 2104 are selected. Those files that are selected are files that will be backed up. In step 2108 of FIG. 21, the widget 124 uploads the selected files to the Scheduling server 110. In step 2110 of FIG. 21, the widget 124 keeps track of all the files that have been selected for backup, e.g., calculating a hash function and storing the path location of the backup files. In step 2112 of FIG. 21, the widget 124 periodically checks the hash function of the updated files, and if changed, the widget 124 performs an incremental backup by uploading the difference of the file.

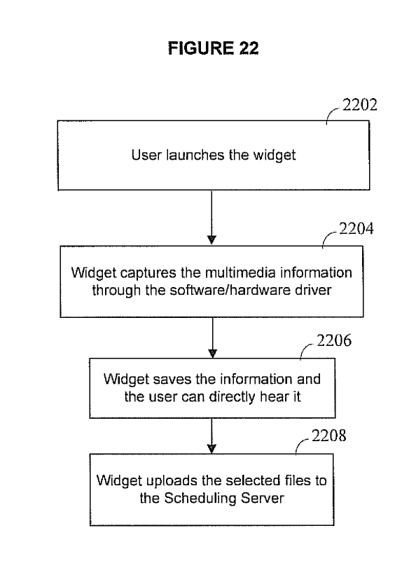

FIG. 22 illustrates a flow diagram for capturing multimedia information through a software or hardware driver. In step 2202 of FIG. 22, the widget 124 is launched. In step 2204 of FIG. 22, the widget 124 captures the desired multimedia information through software and/or hardware drivers. In step 2206 of FIG. 22, the widget 124 saves the discovered information and the user will be able to directly hear or see the multimedia content. In step 2208 of FIG. 22, the widget 124 uploads the selected files to the Scheduling Server.

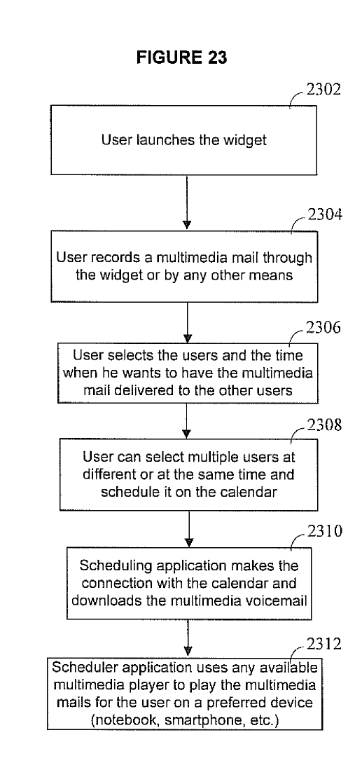

FIG. 23 illustrates a flow diagram for recording and delivering multimedia mail. In step 2302 of FIG. 23, a widget 124 is launched. In step 2304 of FIG. 23, a multimedia mail is recorded through the widget 124 or by any other means for recording an audio and/or video file. In step 2306 of FIG. 23, one or more users are selected to receive the recorded multimedia mail. Further, a date and time is selected for delivery of the multimedia to the selected users. In step 2308 of FIG. 23, one or more users can be selected to receive the multimedia mail at a different or a same time. The times for delivering the multimedia mail are scheduled in a calendar of the scheduling application. Therefore, the multimedia mail is scheduled into a calendar in the same manner as any other multimedia content scheduled for delivery. Each of the users selected for receiving the multimedia mail would therefore receive an invitation to launch the calendar in question to receive the multimedia mail at the desired time. In step 2310 of FIG. 23, the scheduling application makes the connection with the calendar and downloads the multimedia voicemail. In step 2312 of FIG. 23, the scheduler application uses any available multimedia player to play the multimedia mail, at the scheduled date/time for the user on a preferred device (notebook, smart phone, etc.).

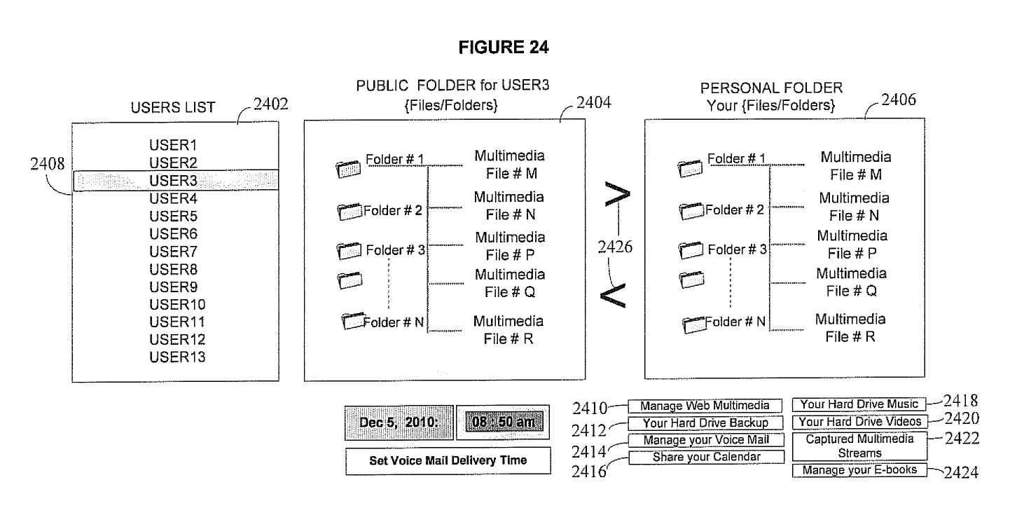

Embodiments of the present invention as illustrated in FIG. 24 enables a user to log on and share a file selection with other users. As illustrated in FIG. 24, a file sharing application within a widget 124 comprises a Users List 2402, a Public Folder 2404 and a Personal Folder 2406. The Users List 2402, illustrated in FIG. 24 provides a list of all associated Users. In one embodiment, after creating a new user in the scheduling service as implemented in the Scheduling server 110, a user can, among the options described above, select one or more other users that will fill the Users List 2402. In one embodiment, the users that fill the Users List 2402 can be other users that desire to send or receive multimedia content to/from the user. As illustrated in FIG. 24, the Public Folder 2404 is the public folder of the selected user, for example, USER3 2408 in the Users List 2402, and contains all the folders and sub-folders that have been placed there by USER3 2408. As discussed above, the USER3's public folder is the folder that other users have access too, i.e., it is available to the public.

As illustrated in FIG. 24, the Personal Folder 2406 can display those folders (and the files or the virtual links they contain) for a particular selected category. In one exemplary embodiment, the Personal Folder 2406 can also contain one or more private folders containing folders and sub-folders that are restricted and not publically accessible unless another user desiring access is in an “Allowed Users” database for that user's private folder, as discussed above and illustrated in FIG. 18. In one embodiment, a private folder or sub-folder of a first user can be further password protected such that only a second user with the password can access the private folder or sub-folder. As illustrated in FIG. 24, the contents of the Personal Folder 2406 will correspond to a selected radio button, such as: Web Multimedia 2410, Hard Drive Backup 2412, Voice Mail 2414, Calendars 2416, Hard Drive Music 2418, Hard Drive Videos 2420, Captured Multimedia streams 2422, and E-books 2424.

Selecting a particular other user (e.g., USER3 2408) from the Users List 2402 will allow the user to see all the files or virtual links to files that are in a public folder for USER3 2408. This allows a user to quickly and efficiently share a particular file with another user. As illustrated in FIG. 24, when a user has logged onto the widget 124 they will have access to a list of users 2402. As discussed above, this list of users 2402 is a listing of other users (USER 1-USER 13) that they desire to share information with and receive information from in return. For example, a user selects USER3 2408 as a destination. After which, the user can select one of the available radio buttons, for example, Manage Web Multimedia 2410. After one of the radio buttons above has been selected, those folders and their files in that particular category (e.g., Web Multimedia 2410) for both the user and USER3 2408 (in this example) are displayed.

While all the files under the category Web Multimedia 2410 for the user are displayed in the Personal Folder 2406, only those Multimedia files that USER3 2408 allows others to see will be displayed in the Public Folder 2404. Using the arrow keys 2426 and highlighting a particular file, the user may quickly and efficiently transfer a file from the user's folder(s) in the Scheduling server 110 to USER3's 2408 Public Folder 2404 in the Scheduling server 110. Selecting a file in USER3's 2408 Public Folder 2404 can also allow the user to transfer such a file to the Personal Folder 2406. The categories displayed in the radio buttons (2410-2424) allow the Public Folder 2404 and the Personal Folder 2406 to be sorted by categories, such that only those types of files will be visible in the Public Folder 2404 and the Personal Folder 2406. FIG. 24 also illustrates that the user can also record a voice mail and select one or more users (USER1-USER13) to receive the voice mail, as well as a date and time for receiving the voice mail.

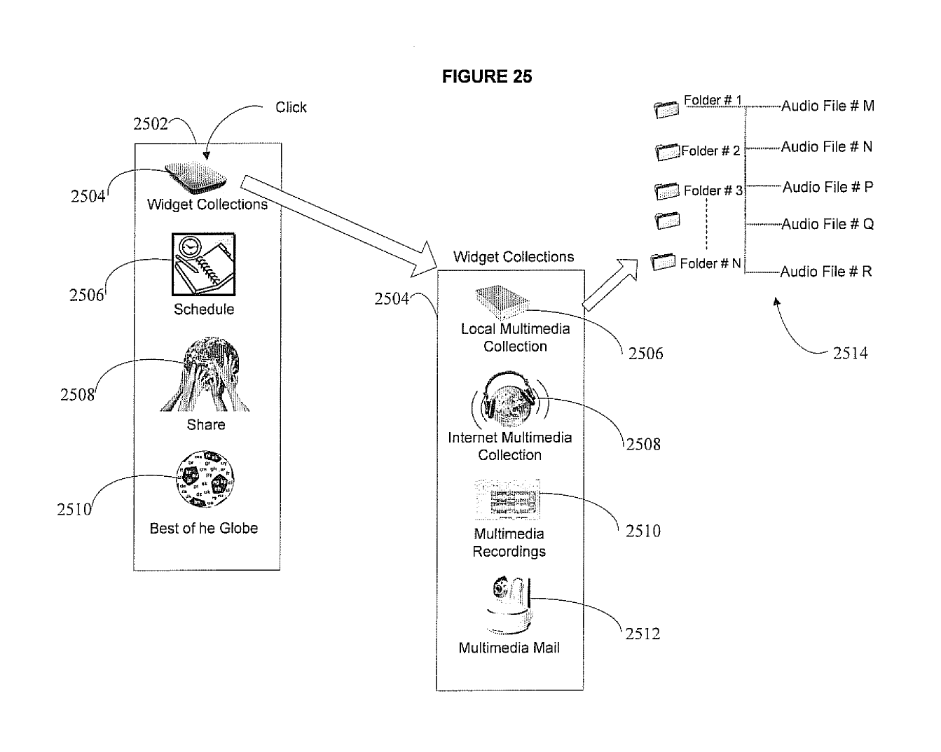

As illustrated in FIG. 25, an exemplary widget 124 can comprise a list of options 2502. For example, the list of options 2502 can comprise a “widget collections” 2504 that contains a list of categories similar to the categories illustrated in FIG. 24. The list of options 2502 can also comprise a Schedule 2506 that accesses calendars as discussed above, the file sharing options 2508 as discussed in FIG. 24, and other options such as a popular webpage 2510.

As illustrated in FIG. 25, when the widget collections 2504 is selected, the widget collections 2504 panel can be displayed. As illustrated in FIG. 25, the Widget Collections 2504 can comprise a Local Multimedia Collection 2506, an Internet Multimedia Collection 2508, Multimedia Recordings 2510, and Multimedia Mail 2512. As further illustrated in FIG. 25, selecting one of the options displayed in the Widget Collections 2504, such as Local Multimedia Collections 2506 can open a file display 2514 containing the associated category of multimedia content.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A method for providing scheduled multimedia content, comprising:
selecting at least one multimedia content for Internet delivery from a plurality of multimedia content available for Internet delivery;
scheduling a time to deliver the selected at least one multimedia content, wherein each selected multimedia content has a corresponding scheduled time for delivery, and wherein the scheduled time for delivery of the selected multimedia content is recorded in a calendar, wherein the calendar is operable to deliver the scheduled multimedia content at the scheduled time for delivery to an Internet-connected device connected to the calendar via the Internet.

2. The method of claim 1, wherein the multimedia content is one of a selectable multimedia file stored in a server of a plurality of servers, and wherein the selected multimedia file is selected via an Internet address specific to the selected multimedia file, wherein the Internet address is a virtual path to the selected multimedia file in the server of the plurality of servers.

3. The method of claim 1, wherein Internet delivery comprises delivering streaming multimedia content from a selected streaming multimedia provider of a plurality of multimedia providers.

4. The method of claim 1, wherein the time for delivery is a date and a time of day on the date, and wherein the time for delivery further comprises a selectable amount of time for the delivery of the selected multimedia content.

5. The method of claim 1, wherein the calendar comprises a plurality of scheduled Internet deliveries, each Internet delivery comprising a separate selected multimedia content of a selected duration of time.

6. The method of claim 2, wherein the selectable multimedia file stored in the server is a backup of a multimedia file in a local storage device.

7. The method of claim 5, wherein the scheduled time for delivery of the selected multimedia content is recorded in at least one of a plurality of calendars.

8. The method of claim 7, wherein an Internet-connected device connects to a selected calendar via an Internet address or virtual path specific to the selected calendar.

9. The method of claim 7, wherein the Internet-connected device connects to the selected calendar after inputting a password, and wherein each calendar has a different password associated with it.

10. The method of claim 9, wherein each calendar has a different plurality of selected multimedia content from a plurality of multimedia providers.

11. A method comprising:
searching for at least one data file on a webpage according to a selected criteria, wherein the searching results in at least one identified data file as meeting the selected criteria;
selecting at least one of the at least one identified data file that meets the selected criteria; and
saving a location of the at least one selected data file.

12. The method of claim 11 further comprising:
searching for at least one data file on at least one of a webpage, a local drive and a remote drive.

13. The method of claim 12, wherein the searching comprises searching for at least one type of multimedia content and returning a list of identified multimedia content that meets the selected criteria, wherein searching for multimedia content comprises capturing get commands for the multimedia content in source code for the webpage.

14. The method of claim 11, wherein saving the location of the at least one selected data file comprises saving an Internet address corresponding to the selected data file, wherein saving the Internet address saves a virtual path to a server storing the selected data file.

15. The method of claim 12, wherein saving the location of the at least one selected data file comprising saving at least one of an Internet address and a file path link to a local or remote drive corresponding to the selected data file.

16. The method of claim 11, wherein the searching further comprises searching a text document for at least one type of data file that meets the selected criteria, wherein the text document comprises source code for the webpage.

17. The method of claim 11, wherein searching for at least one data file comprises searching for the at least one data file on one or more selected webpages, local drives, or remote drives.

18. The method of claim 13 further comprising delivering the saved multimedia content to an Internet-connected device at a selected time, wherein the saved multimedia content is delivered by accessing the saved virtual path to, or disc location of, the saved multimedia content.

19. The method of claim 18, wherein delivering the saved multimedia content is streaming the multimedia content to the Internet-connected device.

20. The method of claim 18, wherein the selected time for delivering the saved multimedia content is immediately or a selected time in the future.
